(19) United States
(12) Patent Application Publication
(10) Pub. No.: US 2005/0183629 A1
(43) Pub. Date: Aug. 25, 2005

(54) Pigment black and dilute dye inks in ink set

(76) Inventors: Sandra Helton McCain, Lexington, KY (US); John Mark Medley, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/783,896

(22) Filed: Feb. 20, 2004

(51) Int. Cl. C09D 11/00

(52) U.S. Cl. 106/31.27; 106/31.6

(57) ABSTRACT

Ink sets comprising, for example, dilute cyan dye-based ink, magenta dye-based ink and black ink of carbon black dispersed by a polymeric dispersant. The dye inks are formulated to not destabilize the black ink. A broader ink set is the forgoing inks in combination with full intensity cyan, magenta and yellow inks used to print full color photographs. The dilute ink and the black ink are in the same printhead.

### TECHNICAL FIELD

This invention is directed to ink sets for printing a range of color intensities and hues, along with black parts, as is for the employed inkjet printing of digital, color photographs.

### BACKGROUND OF THE INVENTION

With the increased emphasis on the generation of photographic images using inkjet technology, a strong focus has recently been placed on specific printing systems for photo printing. To this end, several inkjet manufacturers have introduced printers capable of printing using six, seven, or as many as eight colors to generate photo-realistic inkjet prints that exhibit excellent print quality and permanence (archivability).

This has typically been accomplished by adding one or more photo cartridges containing dilute cyan and magenta, and, optionally, black inks to the existing cyan, magenta, and yellow (CMY) ink set. Each cartridge is based either on dye-based ink technology or on pigment-based ink technology.

Typically, where dye inks and pigment inks are used together in an ink set, incompatibility of the two inks is ignored or considered desirable. Usually the dye inks and the pigment inks are in separate cartridges. When the inks are incompatible they will not flow together, and prevention of such flowing together, often termed bleed, is desirable in printing operations using standard inks. When a pigment ink is incompatible with another ink, the pigment is destabilized and settles from the liquid of the ink, which avoids bleed.

Pigmented black ink, used primarily on plain paper, is superior to dye-based black inks for some applications. The insolubility of pigment such as conventional carbon black renders the pigment less likely to migrate once it is printed on paper. This quality provides enhanced water resistance on plain paper and allows the generation of text and graphics with enhanced edge acuity over dye-based black inks.

Dye based color inks, on the other hand, typically exhibit much brighter color and higher resistance to smearing than pigment-based counterparts. As a result, they are often preferred in some applications.

Depending on the application, these divergent attributes must often be compromised because of the requirement that a particular printhead contain only pigment-based inks or dye-based inks to avoid incompatibility between the two inks.

This invention provides an ink set in which a full range of colors can be printed while two dye-based colors and pigment black are in a single printhead.

### DISCLOSURE OF THE INVENTION

This invention employs the combination of two dilute dye-based inks, such as dilute cyan and magenta inks, with polymer-dispersed pigmented black ink in the same printhead. It can also be applied to other ink combinations. Specifically, a printhead containing four inks, namely dye-based CMY with pigmented black ink, would also fall under the scope of this invention.

The printhead of this invention is to be used along with full intensity inks, such as CMY inks, in one or more separate printheads. This permits full color printing of images, specifically digital photographs. The resulting image has the strong color effects of dye colorants and the pleasing dark effects of pigment black with good image definition.

Broadly, this invention is an ink set of at least two, dilute (low intensity) dye-based inks and dispersed pigment black ink. Additionally, this invention is such an ink set contained in separate compartments in a single ink jet printhead, all inks in that printhead being compatible with the black ink. This invention also encompasses a dye set of full intensity color inks separated from a printhead having at least two dilute dye-based inks and dispersantdispersed pigment ink.

Dilute inks in accordance with this invention typically have an optical density of 60% or less of the optical density of corresponding full strength ink (corresponding inks are inks of similar or identical color (hue)). Typical dilute inks have a dye content as essential colorant of 0.6 percent or less of the weight of the ink. Pigments in accordance with this invention are typically standard carbon black, with the dispersant being a polymer which may take variety of forms. Self dispersed carbon blacks are known. These can add to overall density and the pigment ink in accordance with this invention may well be a mixture of self-dispersed carbon black and polymer-dispersed carbon black.

### BRIEF DESCRIPTION OF THE DRAWINGS

This invention will be described using the accompanying drawings, in which

FIG. 1 is a top, perspective view with cover omitted of a printhead illustrative of that referred which might contain the inks of this invention, and

FIG. 2 is a bottom, perspective view of the printhead of FIG. 1.

### DETAILED DESCRIPTION OF THE PREFERRED EMBODIMENTS

This invention describes the simultaneous use of dye-based inks and pigment-based inks in the same printhead. The benefits of this technology are substantial. Foremost among the advantages of this system is the ability to produce optimized prints on a variety of media without the necessity of purchasing special printheads for divergent applications. Additionally, this technology eliminates the requirement that the consumer physically change the printheads in order to achieve optimum results.

In order to accomplish this marriage of pigment and dye in the same printhead, it is necessary to control the formulations of all of the inks. To this end, several characteristics of the inks have been identified that are necessary for proper function in this system. The main concern resulting from the interaction of the dye-based inks with the pigment-based inks is the destabilization of the pigment dispersion by components in the dye-based ink.

While the dye molecules in the inks may cause some problems, other components in the system are more problematic. Often, multi-valent salts of magnesium or other metals are added to the dye-based inks in order to improve print quality by preventing bleed. To ensure that the function of the pigmented ink is not impaired, it is necessary to optimize the dye-based inks without the use of these salts. On the other hand, pigmented inks are often formulated with the addition of latex binders in order to improve smear resistance. These dispersions are also susceptible to destabilization by the dye-based ink, and should be avoided in order to ensure proper function of all of the inks jetting from the printhead.

Black inks generally consistent with this invention are described in U.S. Pat. No. 6,646,024 B2, assigned to the assignee of this invention. One ink is a mixture of polymer dispersed carbon black and self-dispersed carbon black, and such a mixture is an ink consistent with this invention. Dispersants consistent with this invention are described in U.S. Pat. No. 6,652,634, assigned to the assignee of this invention.

The following tables detail specific examples of inks illustrative of this invention. The following abbreviations are used in the tables:

ProJet Cyan 1—A commercially sold cyan dye, the dye colorant being Direct Blue 199 in an aqueous solution.

Magenta dye—The following describes representative magenta dyes.

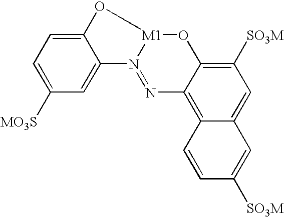

Wherein M1 comprises Cu, Ni, Fe, or Cr, and M comprises —H, —Na, —Li, —K, or an optionally substituted ammonium ion.

Hampene Na3T—A commercially sold trisodium ethylenediaminetetracetic acid (alternative known as trisodium EDTA), a chelating agent.

Proxel GXL—A commercially sold biocide commonly used in inkjet inks.

TEA—Triethanolamine, a buffer.

BES—A commercially sold N,N-bis(2-hydroxyethyl)tuarine or N,N-bis(2-hydroxyethyl)-2-aminoethane sulfuric acid, a buffer.

SILWET 7600—A commercially sold carbon, linear methyl mutiethyloxpropyl siloxane, a surfactant.

2-P—2-pyrrolidone, a cosolvent.

TMP—Trimethyolpropane, a cosolvent.

EG4—Tetraethylene glycol, a cosolvent.

PEG400—Polyethylene glycol, 400 weight average molecular weight, a cosolvent.

Ink Formula 1
Dilute Cyan Dye

| | By Weight Percent |
|---|---|
| DI Water | Balance |
| ProJet Cyan 1 | 0.44% |
| Hampene Na3T | 0.10% |
| Proxel GXL | 0.15% |
| TEA | 0.25% |
| BES | 0.20% |
| 1,2-Hexanediol | 3.00% |
| SILWET 7600 | 0.50% |
| 2-P | 6.25% |
| TMP | 6.25% |
| 1,5-Pentanediol | 6.25% |

Ink Formula 2
Dilute Magenta Dye

| | By Weight Percent |
|---|---|
| DI Water | Balance |
| Magenta Dye | 0.55% |
| Hampene Na3T | 0.10% |
| Proxel GXL | 0.05% |
| 1,2-Hexanediol | 4.00% |
| SILWET 7600 | 0.50% |
| 2-P | 8.00% |
| EG4 | 6.00% |
| Tri-Propylene Glycol | 6.00% |

Ink Formula 3
Representative Pigment Black

| Formulation: | % by Weight |
|---|---|
| Self Dispersant Carbon Black | 2.17 |
| Dispersant Dispersed Carbon Black | 1.08 |
| PEG400 | 9.0 |
| 2P | 9.0 |
| 1,2 Hexanediol | 2.6 |
| Hexylcarbitol | 0.40% |
| DI Water | Balance |

Ink Formula 4
Representative Full Intensity Dye

| FORMULATION | % BY WEIGHT |
|---|---|
| DI Water | Balance |
| ProJet Cyan 1 | 3.0 |
| Dissolvine Na3T | 0.10 |
| Trimethylolpropane | 6.25 |
| 2-Pyrrolidone | 6.25 |
| 1,5-Pentanediol | 6.25 |
| 1,2-Hexanediol | 3.00 |
| Proxel GXL | 0.15 |
| TEA | 0.25 |
| BES | 0.20 |
| SILWET L-7600 | 0.50 |
| Magnesium Nitrate Hexahydrate | 0.30 |
| Sodium Hydroxide to pH 7.5, OR | 0.00 to 0.10 |
| Glacial Acetic Acid down to pH 8.2 | 0.00 to 0.10 |

Ink Formulas 1, 2 and 3 represent the two dilute, low intensity inks and the black ink of this invention. These low intensity inks are compatible with the black ink. Typically, the black ink will be somewhat diluted in intensity, but it may be full intensity. Other dilute color inks may also be included.

Ink Formula 4 represents the full intensity ink pertinent to this invention. Other full intensity inks pertinent to this invention would have magenta dye, yellow dye and may have other colorants. No novelty for the full intensity inks per se is necessary with respect to this invention.

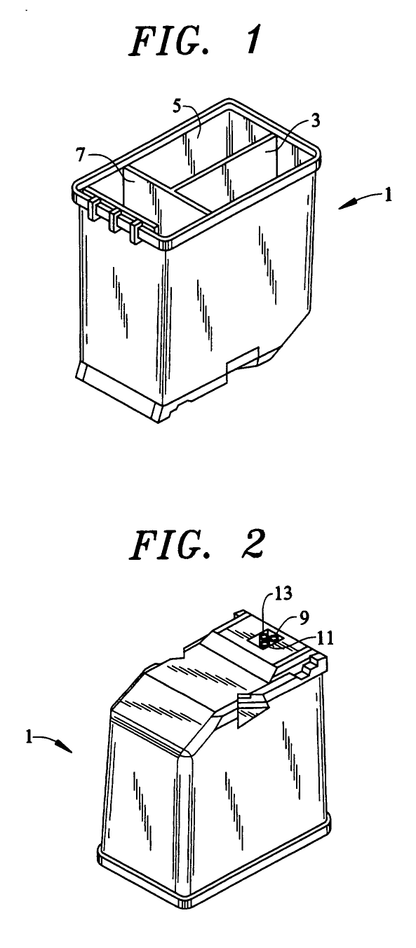

FIGS. 1 and 2 are based on illustrations of U.S. Pat. No. 5,926,195, assigned to the assignee of this invention. The cartridge shown is illustrative of a printhead with which this invention may be employed. As shown in FIG. 1 the printhead 1 has three chambers 3, 5, and 7 in which two dilute color inks and one pigment black ink care kept. Similarly, in a separate cartridge the three chambers 3, 5, and 7 each contain full intensity inks of different colors. Orifices 9, 11, and 13 shown in FIG. 2 permit the ink in each chamber to leave the chamber for printing. Each orifice 9, 11, and 13 is in separate liquid communication with one of the chambers 3, 5, and 7. As is widely practiced, the printhead 1 has a thermal chip or other ink discharge device (not shown) which receives ink from orifices 9, 11, and 13 and applies to ink in small dots or pels on the media being imaged.

Ink exits the printhead 1 from the same side (the side having orifices 9, 11, and 13 in FIG. 2) and generally from locations close together. Moreover, during non-use the printhead is brought to a location at which the exit ports are capped to prevent evaporation of the ink. Accordingly, inks in the typical printheads are subject to some moderate transfer of ink between chambers, such as chambers 3, 5, and 7. In accordance with this invention, the dilute inks must be compatible with the black inks in the moderate amounts which can be transferred across the printhead.

Experimental data shows stability of the foregoing mixtures of dilute dye-based inks and the pigment-based ink. Two inks, one black, were mixed at various ratios and stored at 60° C. for 24 hours. The particle size of the resulting liquid was then measured. Any observed increase in particle size in this experiment indicates instability. The presence of salt (Mg(NO₃)₂) in a cyan ink leads to much greater particle size growth in this test.

A second experiment measures the impact of the contamination of pigmented black ink with dye-based cyan ink in the same printhead. After subjecting the cartridges to severe printing conditions, the number of missing black nozzles was measured. For this experiment, polymer-dispersed pigmented black ink formulated without the addition of latex binder was employed. The same levels of salt (Mg(NO₃)₂) were employed in these cyan inks as in the particle-size test. The presence of salt in the cyan ink causes a substantial increase in the number of black nozzles that are missing after severe printing.

1. An ink set for inkjet printing comprising at least three separate inks in separate chambers in an inkjet printhead with exit orifices for each said chamber, said ink in said chambers being subject to some moderate entry of ink from other of said chambers, said ink set comprising
a first dilute color ink of a first color in a first of said chambers,
a second dilute color ink of a second color in a second of said chambers, and
a black ink comprising black pigment dispersed in water in a third of said chambers,
said first ink and said second ink being compatible with said black ink when in said black ink in moderate amounts.

2. The ink set of claim 1 in which each said first dilute color ink and said second dilute color ink have total color of dye in amount of 0.6 percent or less by weight of the ink of said dye.

3. An ink set comprising:
a first aqueous ink consisting essentially of dye as a colorant of a first color in amount of 0.6 percent or less by weight of the weight of said first ink,
a second aqueous ink consisting essentially of dye as a colorant of a second color in amount of 0.6 percent or less by weight of the of said second ink, and
an aqueous black ink comprising carbon black.

4. The ink set as in claim 3 in which said carbon black is dispersant in said black in by a polymeric dispersant.

5. An ink set for inkjet printing comprising
a first full intensity color ink having dye as colorant,
a second full intensity color ink having dye as colorant,
a third full intensity color ink having dye as colorant,
a first dilute color ink having dye as colorant,
a second dilute color ink having dye as colorant, and
a black ink comprising dispersed black pigment,
wherein said first dilute color ink and said second dilute color ink are compatible with said black ink when in said black ink in moderate amounts.

6. The ink set of claim 5 in which said first dilute color ink, said second dilute color ink and said black ink are contained in separate chambers of a first printhead, each having a exit orifice, said first full intensity in, said second full intensity color ink and said third full intensity color ink being in at least one printhead separate form said first printhead.

7. The ink set of claim 5 in which said colorant of said first dilute color ink and said colorant of said second dilute color ink each is in amount to produce an optical density of less than 60% of the optical density of one of said full intensity inks having a corresponding color.

8. The ink set of claim 6 in which said colorant of said first dilute color ink and said colorant of said second dilute color ink each is in amount to produce an optical density of less than 60% of the optical density of one of said full intensity inks having a corresponding color.
